(19) United States
(12) Patent Application Publication
(10) Pub. No.: US 2006/0035118 A1
(43) Pub. Date: Feb. 16, 2006

(54) Method for detecting a gas leak in a pem fuel cell

(76) Inventors: Detley Coerlin, Erlangen (DE); Harry Gellert, Effeltrich (DE); Walter Stuhler, Hirschaid (DE)

Correspondence Address: HARNESS, DICKEY & PIERCE, P.L.C., P.O.BOX 8910, RESTON, VA, 20195, US

(21) Appl. No.: 10/513,498

(22) PCT Filed: Apr. 24, 2003
(86) PCT No.: PCT/EP03/04269

§ 371 Date: Aug. 1, 2005

(30) Foreign Application Priority Data
May 7, 2002 (EP) 02010338.8

(51) Int. Cl. H01M 8/00

(52) U.S. Cl. 429/13

(57) ABSTRACT

A method is for detecting a gas leak between the anode gas region and the cathode gas region of a PEM fuel cell. According to the method, a) the fuel cell is charged with a direct current, and b) the temporal course of the electrical voltage on the fuel cell is measured. Using only a small amount of equipment, a leak test can be carried out on a fuel cell stack. The test is highly sensitive even to extremely small leaks, but can also be used for large leaks, and indicates the exact position of defective fuel cells within the fuel cell.

This application is the national phase under 35 U.S.C. § 371 of PCT International Application No. PCT/EP03/04269 which has an International filing date of Apr. 24, 2003, which designated the United States of America and which claims priority on European Patent Application number EP 02010338.8 filed May 7, 2002, the entire contents of which are hereby incorporated herein by reference.

### FIELD OF THE INVENTION

The invention generally relates to a method for determination of a gas leak, preferably between the anode gas area and the cathode gas area, in a PEM fuel cell.

### BACKGROUND OF THE INVENTION

A PEM fuel cell (PEM=Polymer Electrolyte Membrane) has a polymer membrane, which conducts ions, as the electrolyte. A gas-permeable, porous, electrically conductive collector is arranged in each case on the anode side and on the cathode side on both sides of the membrane, with a catalyst in a finely distributed form being located between the collector and the membrane.

During operation of the fuel cell, the anode side is supplied with fuel gas, in particular hydrogen or gas containing hydrogen, and the cathode side is supplied with an oxidant, in particular oxygen or a gas containing oxygen, such as air. The hydrogen on the anode of the membrane is oxidized, with the protons that are produced diffusing through the membrane to the oxygen side. These protons recombine on the cathode with reduced oxygen to form water.

Any leakage in the membrane of the PEM fuel cell can lead to a so-called gas short, with hydrogen and/or oxygen passing to the respective opposite gas area, where they react in an exothermic reaction in the catalyst. A leak such as this on the one hand reduces the electrical power of the fuel cell while, on the other hand, particularly if the leak is relatively large, there is a risk of fire occurring in the fuel cell. Leak testing of the fuel cell membrane is thus of major importance.

A pressure maintenance test is frequently carried out as a simple leak testing method. This test allows relatively large leakages to be identified. Normally, two or more fuel cells are combined to form a fuel cell battery or a fuel cell stack. The pressure maintenance test has the disadvantage that a leak in a fuel cell stack detected in this way cannot be associated, at least in a simple manner, with an individual fuel cell in the stack. Furthermore, the sensitivity of the pressure maintenance test is limited to relatively major leaks.

A further method for determination of gas leaks in fuel cells is known, for example, from DE 196 49 434 C1. In this case, a different hydrogen partial pressure is set in the two gas areas of a PEM fuel cell, and the time profile of the cell voltage is measured. The absolute pressures in the anode gas area and cathode gas area should in this case be as different as possible, with a difference of about 1 bar being regarded as being expedient. Undamaged membranes should withstand the load caused in this way, without any risk. In contrast, the use of a test with a membrane which has already been damaged represents a safety risk. For this reason, the test should be preceded by a conventional pressure maintenance test.

### SUMMARY OF THE INVENTION

An embodiment of the invention is based on an object of specifying a simple and reliable method for determination of a gas leak between the anode gas area and the cathode gas area of a PEM fuel cell.

According to an embodiment of the invention, this object may be achieved by a method. During this process, a fuel cell is charged with a direct current. In this case, the time profile of the electrical voltage across the fuel cell is measured. The charging process initiates electrolysis processes, because there is moisture in the PEM cell. In this case, the cell voltage rises gradually to a maximum value. If there is a leak in the cell, hydrogen and oxygen reacts in the form of a gas short, and thus counteracts the rise in the cell voltage.

The leak test method by way of electrical charging of the fuel cell can be used not only for a new PEM fuel cell before it is first used, but also in a rest phase during fuel cell operation. In any case, there must be sufficient moisture in the cell before the start of the process. The method can be used to find the position of a damaged fuel cell within a fuel cell stack, without any problems. All that is required to do this is to measure the voltage individually across the individual cells within the stack.

During the charging process, the current density, related to the fuel cell membrane, is preferably 1 to 10 milliamperes per square centimeter. This allows the method to be carried out quickly. At the same time, this precludes damage to the fuel cell during the test, while allowing sufficiently high measurement sensitivity to be achieved.

The voltage which is applied the fuel cell during the charging process is preferably 0.5 volts to 2 volts, in particular at least 0.8 V and at most 1.5 V. The charging voltage thus corresponds approximately to the fuel cell voltage, that is to say to the voltage which a sound fuel cell produces during normal power supply operation.

According to one preferred development, the method for determination of a gas leak in a PEM fuel cell also has the following further method steps:
the charging of the fuel cell is ended using direct current,
the fuel cell is discharged via a discharge resistance,
the time profile of the voltage drop across the fuel cell during the discharge process is measured.

This measurement of the cell voltage during the discharge process makes it possible to once again verify any leakages with better accuracy. The detection of damaged cells by measurement of the cell voltage during the discharge process is particularly advantageous for cells with minor damage.

The advantage of an embodiment of the invention is, in particular, that it allows a leak test to be carried out on a fuel cell stack with little hardware complexity, which leak test responds very sensitively, even to very small leaks, but which at the same time can also be used for major leaks, and indicates the precise position of damaged cells within the fuel cell stack.

### BRIEF DESCRIPTION OF THE DRAWINGS

An exemplary embodiment of the invention will be explained in more detail in the following text with reference to the drawings, in which:

FIG. 1 shows, schematically, a circuit diagram of an apparatus for carrying out a fuel cell leak test method, and

FIGS. 2a, b show the time profile of the voltage rise and fall during the fuel cell leak test method using an apparatus as shown in FIG. 1.

### DETAILED DESCRIPTION OF THE EXEMPLARY EMBODIMENTS

Mutually corresponding parts and parameters are identified by the same reference symbols in both figures.

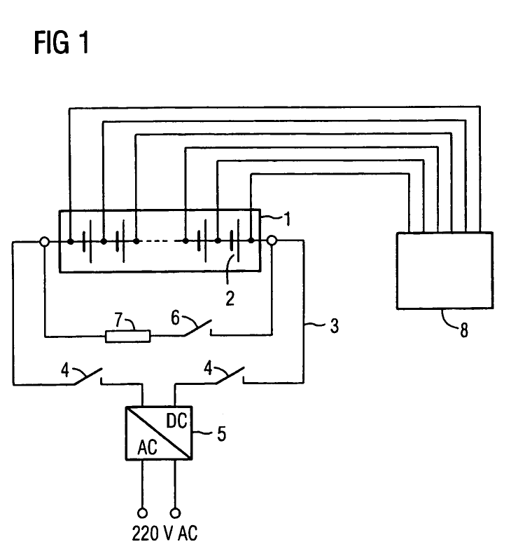

FIG. 1 shows a fuel cell stack or a fuel cell battery 1 with a number of individual PEM fuel cells 2. A controllable power supply or a DC voltage source 5 is connected to the fuel cell stack 1 via supply lines 3 and two switches 4. A discharge resistance 7, which can be switched via a switch 6, is also connected to the fuel cell stack 1. A voltmeter 8 is provided in order to carry out the cell voltage measurements, and is connected individually to all of the PEM fuel cells 2.

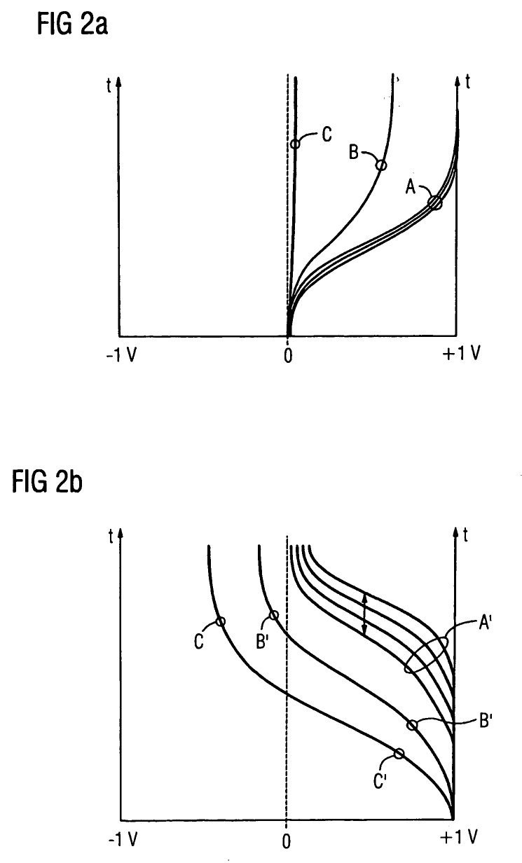

The process of carrying out the leak test method is illustrated, in particular, in FIGS. 2a, b. The gas areas of the individual PEM fuel cells 2 have moisture, that is to say a water content, on both the anode side and the cathode side before the start of the leak test method. The fuel cells 2 are, however, in this case not flooded with water.

At the start of the leak test method, a direct current is passed through the fuel cell stack 1 in such a way that the current density with respect to the fuel cell membranes is approximately 1 to 10 milliamperes per square centimeter. Assuming that all of the PEM fuel cells 2 are intact, the same voltage is dropped across each of these cells during the charging process. The charging voltage is chosen such that a voltage of 1 volt is produced across each cell after the end of the charging process, provided that the individual PEM fuel cells 2 are intact.

The charging process initiates electrolysis processes in the PEM fuel cells 2, that is to say hydrogen and oxygen are formed from the at least small amounts of water in the cells 2. The opposite reaction to that chemical reaction which takes place during normal fuel cell operation, that is to say while the fuel cells 2 are supplying voltage, thus takes place during the charging process.

During the charging process, no gas is supplied to the fuel cell stack 1. The electrolysis processes during the charging process mean that the fuel cell stack 1 can be operated, at least briefly, as an energy source after the charging process. The small amounts of hydrogen and oxygen gas which are formed in the anode gas area and cathode gas area of the individual PEM fuel cells 2 are sufficient for this purpose.

The usable voltage which is produced in this way rises to 1 volt during the charging process if the PEM fuel cells 2 are intact. However, if there is a leak in one PEM fuel cell 2, then the hydrogen and oxygen formed in this cell react directly, that is to say producing a gas short, with one another so that the formation of the usable voltage in the PEM fuel cell 2 is delayed. Finally, the continuing gas short results in the voltage of 1 volt which can be measured with intact cells not being reached, but only a lower voltage whose magnitude depends on the size of the leak in the membrane of the PEM fuel cell 2.

The various measurement curves A, B, C in the diagram illustrated in FIG. 2a relate to different fuel cells 2, which have the following characteristics:
A: There are three intact fuel cells 2. The minor differences between the individual measured fuel cells 2 are caused, in particular, by the fact that the fuel cell membranes allow a small amount of gas diffusion, with the diffusion rates being slightly scattered.
B: The fuel cell 2 can be charged, but considerably more slowly than an intact cell, and not to the full cell voltage of 1 V. The cell has a relatively small leak. Gas which is formed in the anode and/or cathode gas area during the electrolysis process partially moves into the respective other gas area.
C: The fuel cell 2 is virtually impossible to charge. This leads to the conclusion that the fuel cell 2 has a relatively major leak. Virtually all of the hydrogen and oxygen which are formed in the fuel cell 2 react within a short time, forming water. Since the electrolysis process takes place slowly, this exothermic formation of water is, however, not critical from the safety point of view.

The position of the defective fuel cells 2 within the fuel cell stack 1 can be determined without any problems by the charging response of the cells. The leak test method can also be carried out even during assembly of the fuel cell stack 1, before its completion.

FIG. 2b shows the leak test via the discharge behavior of the fuel cells 2. This is based on the assumption that all of the fuel cells 2 which are tested using this method are either intact or at least have such a small leak that they can be charged up to the voltage of 1 V. Once the fuel cells 2 to be tested have been charged to 1 V, they are discharged via a discharge resistance 7 (FIG. 1). The discharge behavior is illustrated in a family of curves A′ for four fuel cells 2, and in two measurement curves B′, C′ for a single fuel cell 2, in each case.

A′: The cell voltage falls gradually to 0 V. In the process, the energy content which was accumulated in the fuel cells 2 during the previous charging is consumed. Although all of the fuel cells 2 whose discharge behavior is represented in the family of measurement curves A′ are intact, the family of curves A′ has a relatively wide scatter width, as indicated by a double-head arrow. This illustrates the very high sensitivity of this test.

B′: The voltage across the fuel cell 2 falls comparatively quickly to 0 V. In this case, the cell is acting as an energy source. The energy supply of the fuel cell 2 is, however, consumed more quickly than in the case of an intact cell. The fuel cell 2 has a very small leak. As soon as the energy supply in the fuel cell 2 has been consumed, the voltage which is measured across the cell changes its mathematical sign, that is to say the fuel cell 2 acts as a resistance after this time. In this case, the energy is supplied by the intact cells within the fuel cell stack 1.

C′: The discharge behavior of the fuel cell 2 is similar to that illustrated by the measurement curve B′, but the fuel cell 2 has a somewhat larger leak.

In the exemplary embodiment, the voltage for charging the fuel cells 2 is applied to the entire fuel cell stack 1. However, it is equally possible to apply a charging voltage specifically to an individual fuel cell 2 within the fuel cell stack 1. The discharge behavior of an individual fuel cell 2 can likewise also be tested, by discharging it on its own via a discharge resistance. In this case, a voltage drop only up 0 V can be measured, even with a damaged fuel cell 2.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for determination of a gas leak between the anode gas area and the cathode gas area of a PEM fuel cell, comprising:
charging the fuel cell with a direct current; and
measuring the time profile of the electrical voltage across the fuel cell.

2. The method as claimed in claim 1, wherein a current density during the charging process is 1 to 10 milliamperes per square centimeter in the PEM fuel cell.

3. The method as claimed in claim 1, wherein the voltage which is applied to the PEM fuel cell during the charging process is 0.5 to 2 volts.

4. The method as claimed in claim 1, further comprising:
ending the charging process using direct current;
discharging the PEM fuel cell via a discharge resistance; and
measuring the time profile of the voltage drop across the PEM fuel cell.

5. An apparatus for carrying out a method as claimed in claim 1, comprising a DC voltage source, connectable to a PEM fuel cell, and voltmeter, connectable to the PEM fuel cell.

6. The method as claimed in claim 2, wherein the voltage which is applied to the PEM fuel cell during the charging process is 0.5 to 2 volts.

7. The method as claimed in claim 2, wherein the voltage which is applied to the PEM fuel cell during the charging process is 0.5 to 2 volts.

8. The method as claimed in claim 6, wherein the voltage which is applied to the PEM fuel cell during the charging process is 0.5 to 2 volts.

9. The method as claimed in claim 2, further comprising:
ending the charging process using direct current;
discharging the PEM fuel cell via a discharge resistance; and
measuring the time profile of the voltage drop across the PEM fuel cell.

10. The method as claimed in claim 3, further comprising:
ending the charging process using direct current;
discharging the PEM fuel cell via a discharge resistance; and
measuring the time profile of the voltage drop across the PEM fuel cell.

11. The method as claimed in claim 6, further comprising:
ending the charging process using direct current;
discharging the PEM fuel cell via a discharge resistance; and
measuring the time profile of the voltage drop across the PEM fuel cell.

12. The method as claimed in claim 7, further comprising:
ending the charging process using direct current;
discharging the PEM fuel cell via a discharge resistance; and
measuring the time profile of the voltage drop across the PEM fuel cell.

13. The method as claimed in claim 8, further comprising:
ending the charging process using direct current;
discharging the PEM fuel cell via a discharge resistance; and
measuring the time profile of the voltage drop across the PEM fuel cell.

14. An apparatus for carrying out a method as claimed in claim 2, comprising a DC voltage source, connectable to a PEM fuel cell, and a voltmeter, connectable to the PEM fuel cell.

15. An apparatus for carrying out a method as claimed in claim 3, comprising a DC voltage source, connectable to a PEM fuel cell, and a voltmeter, connectable to the PEM fuel cell.

16. An apparatus for carrying out a method as claimed in claim 4, comprising a DC voltage source, connectable to a PEM fuel cell, and a voltmeter, connectable to the PEM fuel cell.

17. An apparatus for determination of a gas leak between the anode gas area and the cathode gas area of a PEM fuel cell, comprising:
means for charging the fuel cell with a direct current; and
means for measuring the time profile of the electrical voltage across the fuel cell.

18. The apparatus of claim 17, wherein the means for charging includes a DC voltage source, and the means fro measuring includes a voltmeter.

19. An apparatus for determination of a gas leak between the anode gas area and the cathode gas area of a PEM fuel cell, comprising:
a DC voltage source, adapted to charge the fuel cell with a direct current; and
a voltmeter, adapted to measure the time profile of the electrical voltage across the fuel cell.
